(19) United States
(12) Patent Application Publication
(10) Pub. No.: US 2025/0292367 A1
(43) Pub. Date: Sep. 18, 2025

(54) ARTIFICIAL SATELLITE WITH ONBOARD SENSOR FUSION

(71) Applicant: Xplore Inc., Mercer Island, WA (US)

(72) Inventor: Jeff Rich, Mercer Island, WA (US)

(73) Assignee: Xplore Inc., Mercer Island, WA (US)

(21) Appl. No.: 19/057,506

(22) Filed: Feb. 19, 2025

Related U.S. Application Data
(60) Provisional application No. 63/564,279, filed on Mar. 12, 2024.

(51) Int. Cl. G06T 5/50; G06V 10/764; G06V 20/13

(52) U.S. Cl. CPC G06T 5/50; G06V 10/764; G06V 20/13; G06T 2207/20221; G06V 2201/07

(57) ABSTRACT

The present invention is directed to a small, lightweight artificial satellite with edge computing capabilities. The artificial satellite includes a plurality of high-quality sensors to capture sensor data, which is then processed onboard the artificial satellite prior to transmitting the processed data. The artificial satellite of the present invention overcomes limitations of the prior art by reducing latency and enabling real-time data analytics through edge computing.

### CROSS-REFERENCE TO RELATED APPLICATIONS

This application is related to and claims priority from the following US patents and patent applications: this application claims priority from and the benefit of U.S. Provisional Patent Application No. 63/564,279, filed Mar. 12, 2024, which is incorporated herein by reference in its entirety.

### BACKGROUND OF THE INVENTION

### 1. Field of the Invention

The present invention relates to an artificial satellite capable of performing onboard sensor fusion, and more specifically to individual artificial satellites performing sensor fusion of data from optical sensors, hyperspectral sensors, video generators, and ultraviolet sensors, capable of interacting with the automatic identification system (AIS) with onboard processing for sensor fusion for data produced by each of the sensors.

### 2. Description of the Prior Art

It is generally known in the prior art to provide to provide an artificial satellite with a sensor.

Prior art patent documents include the following:

U.S. Pat. No. 10,496,883 for Method and system for enhancing predictive accuracy of planet surface characteristics from orbit by inventor Kwan, filed Jan. 27, 2017 and issued Dec. 3, 2019, discloses a method and system for enhancing predictive accuracy of planet surface characteristics from orbit using an extended approach of Pan-Sharpening by using multiple high resolution bands to reconstruct high resolution hyperspectral image. Sparsity based classification algorithm is applied to rock type classification. An Extended Yale B face database is used for performance evaluation; and utilizing deep Neural Networks for pixel classification. The present invention presents a system that can significantly enhance the predictive accuracy of surface characteristics from the orbit. The system utilizes complementary images collected from imagers onboard satellites. The present system and method generates high spatial high spectral resolution images; accurate detection of anomalous regions on Mars, Earth, or other planet surfaces; accurate rock/material classification using orbital data and the surface characterization performance will be comparable to in-situ results; and accurate chemical concentration estimation of rocks.

US Patent Publication No. 2003/0095181 for Direct broadcast imaging satellite system apparatus and method for providing real-time, continuous monitoring of earth from geostationary earth orbit by inventor LeCompte, filed Nov. 20, 2002 and published May 22, 2003, discloses a system, method and apparatus for collecting an distributing real-time, high resolution images of the Earth from GEO include an electro-optical sensor based on multi-megapixel two-dimensional charge coupled device (CCD) arrays mounted on a geostationary platform. At least four, three-axis stabilized satellites in Geostationary Earth orbit (GEO) provide worldwide coverage, excluding the poles. Image data that is collected at approximately 1 frame/see, is broadcast over high-capacity communication links (roughly 15 MHZ bandwidth) providing real-time global coverage of the Earth at sub-kilometer resolutions directly to end users. This data may be distributed globally from each satellite through a system of space and ground telecommunication links. Each satellite carries at least two electro-optical imaging systems that operate at visible wavelengths so as to provide uninterrupted views of the Earth's full disk and coverage at sub-kilometer spatial resolutions of most or selected portions of the Earth's surface.

US Patent Publication No. 2018/0167586 for Satellite imaging system with edge processing by inventors Rutschman et. al., filed Dec. 15, 2017 and published Jun. 14, 2018, discloses a satellite imaging system with edge processing includes, but is not limited to, at least one first imaging unit configured to capture and process imagery of a first field of view; at least one second imaging unit configured to capture and process imagery of a second field of view that is proximate to and larger than a size of the first field of view; and a hub processing unit linked to the at least one first imaging unit and the at least one second imaging unit.

US Patent Publication No. 2002/0041328 for Direct broadcast imaging satellite system apparatus and method for providing real-time, continuous monitoring of earth from geostationary earth orbit and related services by inventors LeCompte et al., filed Mar. 29, 2001 and published Apr. 11, 2002, discloses a system, method and apparatus for collecting an distributing real-time, high resolution images of the Earth from GEO include an electro-optical sensor based on multi-megapixel two-dimensional charge coupled device (CCD) arrays mounted on a geostationary platform. At least four, three-axis stabilized satellites in Geostationary Earth orbit (GEO) provide worldwide coverage, excluding the poles. Image data that is collected at approximately 1 frame/see, is broadcast over high-capacity communication links (roughly 15 MHz bandwidth) providing real-time global coverage of the Earth at sub-kilometer resolutions directly to end users. This data may be distributed globally from each satellite through a system of space and ground telecommunication links. Each satellite carries at least two electro-optical imaging systems that operate at visible wavelengths so as to provide uninterrupted views of the Earth's full disk and coverage at sub-kilometer spatial resolutions of most or selected portions of the Earth's surface.

U.S. Pat. No. 10,647,449 for Indirect self-imaging systems and methods by inventors Wasson et al., filed May 30, 2018 and issued May 12, 2020, discloses a system includes a controller configured to determine a set of background light intensities associated with a satellite, where each background light intensity corresponds to at least one of an orientation and a position of a light source relative to the satellite, to determine a set of relative orientations of the light source corresponding to the set of background light intensities, and to generate an image of the satellite based, at least in part, on the determined set of background light intensities and the determined set of relative orientations of the light source.

U.S. Pat. No. 11,496,679 for Real-time satellite imaging system by inventor Williams filed Feb. 8, 2021 and issued Nov. 8, 2022, discloses methods and apparatus for Real-time Satellite Imaging System. More particularly, one embodiment of the present invention an imaging sensor on a geostationary satellite having one or more co-collimated telescopes. The telescopes illuminate local planes which are sparsely populated with focal plane arrays. The focal plane arrays record the entire observable Earth hemisphere at one time, at least once every ten seconds.

U.S. Pat. No. 7,090,170 for In-orbit satellite sensor alignment determination by inventor Kau, filed Nov. 22, 2002 and issued Aug. 15, 2006, discloses a sensor alignment system and method is provided that facilitates the precise alignment determination of satellite sensors. The system and method utilizes an Inertial Measurement Unit (IMU) to facilitate alignment determination of multiples sensors on a satellite. The system and method performs a roll of the satellite around a preliminary sensor active axis, using the IMU to measure the rotation rate in both magnitude and direction. The sensor input is monitored by the IMU during the roll around the preliminary sensor axis. The data from sensor output obtained during the roll can be processed to calculate the difference between the preliminary sensor axis and the actual sensor axis. From this calculation the actual alignment of the sensor axis can be determined. Furthermore, by performing this alignment determination operation for multiple sensors the relative alignment between sensors can be determined.

US Patent Publication No. 2020/0371373 for Focal plane assembly of remote sensing satellite and image processing method thereof by inventors Ling et al., filed Jun. 24, 2019 and published Nov. 26, 2020, discloses a Focal Plane Assembly (FPA) of a remote sensing satellite for receiving a focal plane image provided by an optical lens, comprises a sub-pixel shifting field separator, a first linear image sensor, and a second linear image sensor. The field separator split the focal plane image up into a first half focal plane image and a second half focal plane image, the first linear image sensor, located at an edge of a half focal plane, receives the first half focal plane image to generate a first image, the second linear image sensor, located at an edge of another half focal plane, receives the second half focal plane image to generate a second image, wherein a sub-pixel shifting relation is between the first image and the second image.

US Patent Publication No. 2022/0242593 for Artificial satellite and control method thereof by inventors Ezawa, et al., filed Dec. 3, 2021 and published Aug. 4, 2022, discloses an artificial satellite and a control method thereof that enable to ensure quality of a captured image while suppressing battery consumption. An artificial satellite includes: an imaging device configured to perform imaging of a predetermined region on the ground; and a management unit configured to change accuracy of attitude control in accordance with a remaining battery amount at an instructed imaging time, and configured to change an imaging condition in accordance with accuracy of the attitude control. The present technology can be applied to, for example, an artificial satellite or the like that performs satellite remote sensing by formation flight.

Chinese Patent No. 110,516,588 for Remote sensing satellite system by inventors Weijian et al., filed Aug. 23, 2019 and issued Apr. 18, 2023, discloses a remote sensing satellite system which comprises a first satellite, wherein the first satellite comprises at least four image sensors, the at least four image sensors are used for simultaneously acquiring images of the ground, the ground areas acquired by the at least four image sensors are completely or partially overlapped, the spatial resolution and the spectral resolution of the images acquired by the at least four image sensors are different from each other, and the first satellite is used for carrying out image fusion on at least one part of the images acquired by the at least four image sensors so as to generate a fused remote sensing image. The invention can efficiently obtain the remote sensing image with high definition by using the limited resources of the satellite.

Chinese Patent No. 109,018,432 for High-precision comprehensive remote sensing satellite layout for multi-load cooperative observation by inventors Jinru et al., filed Jun. 19, 2018 and issued May 29, 2020, discloses a high-precision comprehensive remote sensing satellite layout for multi-load cooperative observation, which effectively ensures harsh working environments of active detection loads such as laser radars and the like through an eccentric deflection high-precision high-stability installation layout; by means of common reference installation, transmission path reduction and the like, the requirement of low-deformation precision cooperative observation of dual-polarization load angle grading view field registration is met, and an interface between systems is simplified; based on the existing mixed nested layered stepped satellite platform configuration, the overall installation layout of the complex constraint load/antenna/attitude sensor with the same platform, various types, different envelopes, weights and use requirements, and multi-hand synthesis is realized, the satellite development risk and cost are reduced, and the satellite development period is shortened. The invention can be applied to the low-orbit comprehensive remote sensing satellite with the cooperative observation requirements of the loads with different envelopes and different weights on the same platform, which has the advantages of large volume envelope, large concentration mass, large heat flow density, high-precision and high-stability installation and complex visual field constraint.

Chinese Patent Publication No. 109,844,471 for Spectral luminosity measuring device with multiple spectral measurement wave bands by inventor Pasternak, filed Sep. 29, 2017 and published Apr. 27, 2021, discloses a spectrophotometric measuring device has a plurality of spectral measuring bands, including a single telescope and a single spectrophotometer. A plurality of spectral bands are obtained by placing aperture splitting prisms at the entrance aperture (PE) of the telescope and by using a spectral band selection filter. Such devices are lightweight, small in size and low in cost. In particular, it can be integrated into satellites, in particular for the task of characterizing the flow of carbon compounds generated at the surface of the earth.

Chinese Patent Publication No. 108,557,114 for A kind of distribution remote sensing satellite by inventors Yong et al., filed Apr. 18, 2018 and published Sep. 21, 2018, discloses a kind of distributed remote sensing satellites comprising a service star and six remote sensing unit stars, and distributed formation mode or synthetic aperture integrated mode can be used in the service star and remote sensing unit star.

Canadian Patent No. 3067604 for System and method for widespread low cost orbital satellite access by inventor Platzer, filed Feb. 3, 2014 and issued Jul. 12, 2022, discloses a large constellation of low-cost satellites with a satellite support and administration system that allows widespread user access to advanced satellite technology at extremely low costs. Any portion of the constellation can be tasked and configured for specific data capture. In one embodiment, a constellation of individual satellites are employed to concurrently collect occultation data from multiple GPSS originating signals that pass through atmospheric sections of interest. Alternately, the constellation can be configured as a vehicle location tracking system that receives multiple vehicle tracking signals and based thereon, track within a system grid each vehicle under surveillance. The system can use AIS for ocean going vessels, ADS-B for aircraft, and AEI for trains. Use of the system permits extended tracking of key cargos and the protection of vehicles from piracy and the like.

### SUMMARY OF THE INVENTION

The present invention is generally directed to an artificial satellite capable of performing onboard sensor fusion, and more specifically to individual artificial satellites performing sensor fusion of data from optical sensors, hyperspectral sensors, video generators, and ultraviolet sensors, capable of interacting with the automatic identification system (AIS) with onboard processing for sensor fusion for data produced by each of the sensors.

It is an object of this invention to provide a single artificial satellite with a plurality of sensor types, with the satellite capable of onboard sensor fusion for data produced by the plurality of sensor types to perform tasks such as pan sharpening.

In one embodiment, the present invention is related to an artificial satellite, including a plurality of computer processors each including a memory, a plurality of sensors operable to capture image data, and at least one transceiver, wherein the plurality of computer processors includes at least one flight processor and at least one payload processor, wherein the at least one payload processor is operable to automatically correct the image data via orthorectification, georectification, radiometric correction, and/or pan sharpening, wherein the at least one payload processor includes an artificial intelligence engine operable to classify objects, identify objects, and/or tag objects within the image data, and wherein the at least one payload processor is operable to fuse images having common object classifications, common object identifications, and/or common object tags.

In another embodiment, the present invention is related to an artificial satellite, including a plurality of computer processors each including a memory, a plurality of sensors operable to capture image data, and at least one transceiver, wherein the plurality of sensors are mounted to at least one gimbal, wherein the plurality of computer processors includes at least one flight processor and at least one payload processor, wherein the at least one payload processor is operable to automatically correct the image data via orthorectification, georectification, radiometric correction, and/or pan sharpening, wherein the at least one payload processor includes an artificial intelligence engine operable to classify objects, identify objects, and/or tag objects within the image data, and wherein the at least one payload processor is operable to fuse images having common object classifications, common object identifications, and/or common object tags.

In yet another embodiment, the present invention is related to an artificial satellite, including a plurality of computer processors each including a memory, a plurality of sensors operable to capture image data, and at least one transceiver, wherein the plurality of sensors are mounted to at least one gimbal, wherein the at least one gimbal is operable to rotate about a plurality of axes, wherein the at least one transceiver is operable to receive at least one uplink message from at least one ground station instructing the plurality of sensors to target a common destination, wherein the plurality of computer processors includes at least one flight processor and at least one payload processor, wherein the at least one payload processor is operable to automatically correct the image data via orthorectification, georectification, radiometric correction, and/or pan sharpening, wherein the at least one payload processor includes an artificial intelligence engine operable to classify objects, identify objects, and/or tag objects within the image data, and wherein the at least one payload processor is operable to fuse images having common object classifications, common object identifications, and/or common object tags.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1 illustrates a perspective view of an artificial satellite with a plurality of sensors according to one embodiment of the present invention.

FIG. 2 illustrates a schematic diagram of data flow between a satellite having a plurality of sensors communicating with one or more ground stations.

FIG. 3 is a schematic diagram of a system of the present invention.

### DETAILED DESCRIPTION

The present invention is generally directed to an artificial satellite having more than one sensor, and more specifically to individual artificial satellites including optical sensors, hyperspectral sensors, video generators, and ultraviolet sensors, capable of interacting with the automatic identification system (AIS) with onboard processing for sensor fusion for data produced by each of the sensors.

In one embodiment, the present invention is related to an artificial satellite, including a plurality of computer processors each including a memory, a plurality of sensors operable to capture image data, and at least one transceiver, wherein the plurality of computer processors includes at least one flight processor and at least one payload processor, wherein the at least one payload processor is operable to automatically correct the image data via orthorectification, georectification, radiometric correction, and/or pan sharpening, wherein the at least one payload processor includes an artificial intelligence engine operable to classify objects, identify objects, and/or tag objects within the image data, and wherein the at least one payload processor is operable to fuse images having common object classifications, common object identifications, and/or common object tags.

In another embodiment, the present invention is related to an artificial satellite, including a plurality of computer processors each including a memory, a plurality of sensors operable to capture image data, and at least one transceiver, wherein the plurality of sensors are mounted to at least one gimbal, wherein the plurality of computer processors includes at least one flight processor and at least one payload processor, wherein the at least one payload processor is operable to automatically correct the image data via orthorectification, georectification, radiometric correction, and/or pan sharpening, wherein the at least one payload processor includes an artificial intelligence engine operable to classify objects, identify objects, and/or tag objects within the image data, and wherein the at least one payload processor is operable to fuse images having common object classifications, common object identifications, and/or common object tags.

In yet another embodiment, the present invention is related to an artificial satellite, including a plurality of computer processors each including a memory, a plurality of sensors operable to capture image data, and at least one transceiver, wherein the plurality of sensors are mounted to at least one gimbal, wherein the at least one gimbal is operable to rotate about a plurality of axes, wherein the at least one transceiver is operable to receive at least one uplink message from at least one ground station instructing the plurality of sensors to target a common destination, wherein the plurality of computer processors includes at least one flight processor and at least one payload processor, wherein the at least one payload processor is operable to automatically correct the image data via orthorectification, georectification, radiometric correction, and/or pan sharpening, wherein the at least one payload processor includes an artificial intelligence engine operable to classify objects, identify objects, and/or tag objects within the image data, and wherein the at least one payload processor is operable to fuse images having common object classifications, common object identifications, and/or common object tags.

These and other aspects of the present invention will become apparent to those skilled in the art after a reading of the following description of the preferred embodiment when considered with the drawings, as they support the claimed invention.

None of the prior art discloses a single artificial satellite operable to support a plurality of sensors as disclosed in the present application, especially a plurality of sensors for imaging, optically or otherwise, terrestrial features, capable of supporting onboard sensor fusion and onboard processing such as pan sharpening, to enable lower latency tasks involving satellite-generated data.

Artificial satellites have a variety of uses and have become an integral part of modern life. Artificial satellites aid in Earth observation, outer space observation, communication systems, navigation systems, and even weapon systems. Traditionally, artificial satellites include electricity generation systems, such as solar panels, to power the onboard equipment. Importantly, artificial satellites require a power generation system operable to produce enough power to support its onboard equipment, otherwise the equipment cannot function. Consequently, the greater the number of sensors or the greater the power demand of the sensors, the more power need by the power generation system. Therefore, there is a need for an artificial satellite capable of supporting multiple sensors.

However, the issue with the distribution of sensors around a constellation, or multiple constellations of satellites, rather than integrated on a single satellite, is not just the number of satellites required, but the increased latency that this prior art system of organization necessarily requires. For example, the existing system requires a ground station to essentially ping the satellite for specific data, and likely needing to ping multiple satellites for multiple data sets, transmit the information back down to the ground station, perform sensor fusion, post-process the data, and then subsequently transmit the relevant information to an intended destination. Therefore, a system that provides onboard sensor fusion and data processing allows the processed data to be immediately transferred from the processing satellite to the intended destination, without requiring that the tasking ground station receive the information as an intermediary. Thus, a system is needed to resolve the inefficiency of current satellite communication.

In one embodiment, the artificial satellite includes at least two sensors. In one embodiment, the artificial satellite includes at least three sensors. In one embodiment, the artificial satellite includes at least four sensors. In one embodiment, the artificial satellite includes at least five sensors. In one embodiment, the artificial satellite includes at least three sensors wherein at least one sensor is a high-power, high-resolution sensor. In one embodiment, the artificial satellite includes a plurality of sensors.

In one embodiment, the artificial satellite is of a small size and is not a large spacecraft. In one embodiment, the artificial satellite weighs approximately 180 kg.

One of ordinary skill in the art will understand that the inclusion of onboard processing and multiple sensors on a single satellite does not mean that the satellite of the present invention is not able to be included in a constellation of a plurality of satellites. In one embodiment, a satellite of the present invention is included in a constellation of 15 satellites, or any other number of satellites. In some embodiments, use of a plurality of satellites according to the present invention provides an advantage due to the different angles at which different satellites in the constellation are able to observe the same feature or different features, even if the different satellites include substantially the same type of sensors.

In one embodiment, the satellite is able to communicate with ground stations or with other satellites in a constellation via S-band (approximately 2-4 GHz, or more particularly 2.31-2.36 GHz, 2-2.2 GHZ, or approximately 2.6 GHZ), X-band (approximately 7-11.2 GHz, or more particularly 7.25 GHz to 7.75 GHz or 7.9 GHZ to 8.4 GHZ), low latency L-band (approximately 1-2 GHz, or more particularly frequencies such as 1176.45 MHz, 1227.6 MHz, 1381.05 MHz, or 1575.42 MHz), via optical inter-satellite link (OISL) communications, or via Ka-band radar (between approximately 26.5-40 GHz, or more particularly between approximately 27 GHz and 31 GHz).

In a preferred embodiment, the plurality of sensors includes a Red, Blue, and Green (RGB), an optical sensor, two hyperspectral sensors, one automatic identification system (AIS) receiver, and two ultraviolet instruments (e.g., two ultraviolet telescopes). In one embodiment, the plurality of sensors includes any number or combination of at least one RGB video telescope, at least one hyperspectral sensor, at least one ultraviolet instrument, at least one infrared spectrometer, and/or at least one AIS receiver. In one embodiment, the plurality of sensors include one or more optical sensors, one or more hyperspectral sensors, one or more infrared sensors (e.g., infrared cameras, infrared telescopes, infrared spectrometers, etc.), one or more ultraviolet sensors, one or more AIS receivers, one or more radiofrequency receivers, one or more dosimeters, one or more magnetometers, one or more LiDAR sensors, one or more spectrometers, one or more automatic dependent surveillance-broadcast (ADS-B) systems, and/or one or more synthetic aperture radar (SAR) systems. In one embodiment, the artificial satellite includes at least one RGB video telescope and at least one hyperspectral sensor. In one embodiment, the artificial satellite includes at least one RGB video telescope, at least one hyperspectral sensor, and at least one ultraviolet instrument. In one embodiment, the artificial satellite includes at least one RGB video telescope, at least one hyperspectral sensor, at least one ultraviolet instrument, and at least one infrared telescope. In one embodiment, the plurality of sensors includes any combination of five or fewer of the aforementioned sensors.

In one embodiment, the plurality of sensors are operable to capture image data. In one embodiment, the artificial satellite includes at least one transmitter operable to transmit the image data from the plurality of sensors. In one embodiment, the artificial satellite includes at least one transceiver operable to transmit and receive data.

In one embodiment, the satellite includes a plurality of onboard processing computers configured to perform tasks such as sensor fusion and other processing of the data generated from the plurality of sensors. In a preferred embodiment, the satellite includes two flight processors (i.e., processors dedicated to tasks relating to the movement and navigation of the satellite) and four payload processors (i.e., processors dedicated to processing tasks related to the sensors), but one of ordinary skill in the art will understand that other combinations of flight and payload computers are also contemplated herein. In one embodiment, the satellite includes approximately 10 TB of memory storage.

Examples of processing tasks able to be performed by the payload processors onboard the satellite include orthorectification, other georectification, radiometric correction, and pan sharpening, among others. Orthorectification is a form of georectification that is important for removing distortion from the image data produced by sensors onboard the satellite, and is especially important such that measurements such as distances, angles, and areas of features in the image data is able to be accurately determined. The distortion corrected in orthorectification is typically caused by differences in elevation of the area being imaged (e.g., due to mountains, valleys, buildings, etc.), the curvature of the Earth, the tilt of the imaging device on the satellite, and the movement of the satellite while the image is being generated. Without orthorectification, the elevation differences cause the actual position of imaged objects to be displaced from their actual position, making tasks that require actual mapping difficult if not impossible. In the prior art, this process of orthorectification occurs on a ground station after image data from the satellite is received, using a digital elevation model (DEM), commonly generated from multiple full passes of satellite mapping by separate satellites, which often include LiDAR, Radar, or stereophotogrammetric based sensors. However, this process introduces large amounts of latency, both in the generation of a sufficient DEM model to provide an accurate orthorectification, and in the actual transmission back to a ground station for the post-processing.

The present invention overcomes these limitations of prior art orthorectification by performing the orthorectification onboard the satellite itself using the payload processors. In one embodiment, a DEM is generated for orthorectification using sensor data from other sensors onboard the same satellite (e.g., optical sensors, video sensors, ultraviolet sensors, etc.), either using the same type of sensor oriented at a different angle, or using different types of sensors from the sensor data being rectified. Alternatively, the satellite is able to communicate with other satellites in a constellation also generating sensor data using the same or different types of sensors and process this data from other satellites along with data generated by the processing satellite itself in order to orthorectify the mapping image. In this way, the present invention does not require the data to be transmitted and processed at a ground station, but is instead able to be processed onboard and transmitted directly to the target destination.

The satellite according to the present invention is also able to perform radiometric correction using the onboard payload processors of the satellite. Radiometric correction is important for obtaining accurate pixel values for the images obtained by one or more sensors on the satellite to ensure that the images are accurate and comparable to other images. The correction involves converting the digital numbers (DNs) of the satellite image to spectral radiance and reflectance. This often requires calibration and processing to eliminate weather-related distortion of the images, which is often variable depending both on current weather conditions and on the current season in which the images are produced. Some methods for calibration and other forms of correction are able to be performed without secondary sensor data using known calibration factors for a particular area during a particular time period, or using correlation to baseline data for an area, as discussed in the article Radiometric Correction with Topography Influence of Multispectral Imagery Obtained from Unmanned Aerial Vehicles by Jenerowicz et al., which is incorporated herein by reference in its entirety. Alternatively, the present system is able to use data from different imaging systems on the same satellite (or from other satellites in a constellation) to prevent for an amount of correction needed for weather effects or to calibrate the image data (e.g., infrared sensor data used to provide correction for hyperspectral image data, etc.).

The satellite of the present invention is further capable of performing pan sharpening using the onboard payload processors. One critique of satellite imagery is that with a single sensor, the image data from the satellite either only has quality spatial resolution or spectral resolution, with one of these two qualities lacking. Existing pan sharpening methods have reconciled this tradeoff by using sensor fusion between a panchromatic image and multispectral image of the same area to sharpen the image to have both high spectral and spatial resolutions. However, as with other processing techniques, the nature of prior art systems as only including a single sensor or imaging systems means that this pan sharpening generally requires sensor fusion to be performed at a ground station to receive image data from two different satellites. However, because the satellite of the present invention includes a plurality of sensors, including those capable of producing both panchromatic and multispectral images, such sensor fusion is able to be performed using sensor data produced by sensors on a single satellite. Furthermore, the satellite is then able to further processing needed to perform the pan sharpening processing with the onboard payload processors. One of ordinary skill in the art will understand that, according to another embodiment, a first satellite is able to receive image data from one or more other secondary satellites used to sharpen images produced by the first satellite and then perform the pan sharpening using the onboard payload processors.

In one embodiment, the plurality of sensors are mounted on at least one gimbal. In one embodiment, the at least one gimbal is a pivoted support member that permits rotation about a plurality of axes. In one embodiment, the gimbal enables the plurality of sensors to rotate independent of the movement or rotation of the artificial satellite. In one nonlimiting example, the at least one gimbal enables the plurality of sensors to be directed towards the Earth while the artificial satellite, or the solar array of the artificial satellite in one embodiment, is directed towards the sun.

In one embodiment, the at least one RGB video telescope is operable to capture 8K full-color video, that is video with approximately 8,000 pixel resolution.

In one embodiment, the at least one hyperspectral sensor is operable to produce 5-meter resolution hyperspectral imaging. The hyperspectral imaging includes chemistry data for agriculture, security, energy, and environmental monitoring. The hyperspectral sensor is operable to capture 440 bands of electromagnetic data. The hyperspectral sensor is operable to collect electromagnetic data in a series of set images with each image representing a specific narrow wavelength. The images are then combined to create a three-dimensional hyperspectral data set for processing and analysis. In one embodiment, the hyperspectral data set includes x and y coordinates representing two spatial dimensions of the captured area with a third λ coordinate representing the spectral dimension or range of wavelengths captured.

In one embodiment, the at least one ultraviolet instrument is operable to capture electromagnetic radiation data in the ultraviolet range (100-400 nm). In this embodiment, the ultraviolet telescope is operable to capture line spectrum data within the ultraviolet range to determine chemical compositions, densities, and temperatures of the captured area. Advantageously, the ultraviolet instrument provides information about the evolution of galaxies, the presence of hot white dwarfs, and main sequences in orbit around cooler stars.

In one embodiment, the at least one infrared spectrometer is operable to capture electromagnetic radiation data in the infrared range (780-1000 nm). In this embodiment, the infrared spectrometer is operable to capture line spectrum data within the infrared range to monitor greenhouse gases in the captured area. In one embodiment, the infrared spectrometer is operable to produce infrared spectrum data. Infrared spectrum data is visualized on a graph with a vertical axis of infrared light absorbance against frequency, wavenumber, and/or wavelength on the horizontal axis.

In one embodiment, the at least one AIS receiver is operable to receive AIS signatures from ships for vessel traffic services (VTS). In one embodiment, the AIS signatures include unique identification, position, course, and speed data. In one embodiment, the artificial satellite is operable to deconflict AIS signatures. In one embodiment, the artificial satellite includes a transceiver operable to transmit the AIS signatures. Advantageously, by inclusion of the AIS receiver, the artificial satellite assists vessels' watchstanding officers and enables maritime authorities to track and monitor vessel movement.

In one embodiment, the satellite according to the present invention receives tasks as uplink messages from at least one ground station. In one embodiment, the tasks are routed through one or more relay satellites (e.g., via another constellation such as the Iridium network). The tasks designate a desired type of data to generate, including raw sensor data, and/or processed sensor data based on raw sensor data from one or more of the sensors onboard the satellite. In one embodiment, the tasks include a target (e.g., a destination device or node), a time (e.g., time at which task was sent, time at which the data should be delivered, etc.), one or more designated sensors to utilize, a designated data product, analytics, and/or a desired distribution method or path for the task and/or for the data (e.g., which relay networks to use, what frequency bands to utilize, etc.). In one embodiment, the tasks include a destination device or node to which the information is to be delivered. The destination device or node is able to be the same or distinct from the device or node transmitting the task to the satellite, and is able to include both in-orbit, aerial, or terrestrial devices. In one embodiment, the raw sensor data and/or processed sensor data generated as a result of the task is able to be routed through one or more relay satellites or ground station to the destination end user device or node. Because the processing for the task is able to be, partially or entirely, performed on-board the satellite, the data from the satellite does not need to be routed back through the task-transmitting ground station before being send to the destination and is instead able to be directly transmitting by the satellite to the destination device or node.

In one embodiment, tasks are able to be input into a tasking application or application programming interface (API) on a user device (e.g., a cell phone, a computer, a tablet, etc.). In one embodiment, the tasking application or API includes set parameters to input (e.g., target, time, sensors, analytics, distribution path, etc.) for the task being transmitted and is able to set certain categories of information as mandatory or discretionary.

The range of applications and technical fields for each task are able to be generated and requested vary widely. In one contemplated embodiment, the tasks relate to identification of the relative or absolute (i.e., actual geodetic) locations of a plurality of vessels, such as ships, within a specific area. This is especially useful in situations where the ships lack an AIS transponder, where the AIS transponder is malfunctioning, or where the AIS transponder is otherwise unable to communicate to transmit information. The application to maritime situations is useful for a variety of situations, including rescue for ships, port management and security, and for warfare applications where non-transmitting vessels need to be identified. For applications such as these, the low latency enabled by the onboard sensor fusion and data processing aboard the satellites is critical for enabling sufficiently fast determinations of vessel locations to be made.

Sensor fusion of the particular sensors of the present invention, such as the combination of the imaging sensors (e.g., hyperspectral, RGB video, etc.) and the AIS receiver, allows for enhancing of the results of the individual sensors to provide for unique results. For example, in instances in a ship is imaged in the middle of the ocean or sea without any geographic features nearby, the AIS receiver is able to be used to provide a geolocation (e.g., a GPS location) for the ship so as to allow the ship to serve as a geodetic marker for the image, allowing for the image including the ship to be better combined with other image data to create a complete mapping of an area. On the other hand, use of the imaging sensor is able to be used to provide context or additional information regarding an AIS located vessel, or able to back fill to determine a location of the vessel even if the AIS transponder of the vessel is not functioning or is out of range of other receivers.

In one embodiment, the payload processors are able to perform a variety of processing tasks, including classification, identification, and tagging of identified objects in images produced by the sensors on the satellite. In one embodiment, this classification, identification, and tagging is performed by, at least in part, one or more artificial intelligence or machine learning (AI/ML) modules that form part of the payload processors. By way of example and not limitation, tasks are able to be assigned to command the payload processors to automatically detect ships, planes, other vehicles, buildings (or specific building types), terrain features, people, animals, weather phenomena (e.g., fires, tornadoes, etc.), and/or other features in the images and automatically provide geolocation data for one or more of the identified features. In one embodiment, the payload processors are able to perform tasks identifying changes to the images and/or changes to one or more identified objects in the images. For example, in one embodiment, the payload processors are operable to perform onboard pattern of life analysis, change analysis, and/or anomaly detection based on the image or video data produced by the plurality of sensors on the satellite. In one embodiment, the payload processor is able to determine an approximate velocity, direction, acceleration, and/or position of one or more objects identified in the images or video produced by the plurality of sensors.

In one embodiment, the payload processors are able to provide homomorphic encryption and/or other forms of encryption for the sensor data before transmitting the sensor data to the destination device or node.

In one embodiment, the present invention demonstrates low-latency, with a delay of only between about 5 seconds and about 20 seconds for the task to reach the satellite from the ground station and about 5 seconds to about 20 seconds for the data generated by the satellite to reach the destination device or node.

In one embodiment, the plurality of sensors are operable to capture image data from the Earth for Earth observation, weather forecasting, agriculture monitoring, and/or greenhouse gas monitoring. In one embodiment, the plurality of sensors are operable to capture image data from outer space to collect information about planets, meteorites, stars, distant galaxies, and/or other outer space objects.

In one embodiment, the plurality of sensors are all directed to a common target, simultaneously and are operable to obtain image data from the plurality of sensors on the same common target. In this embodiment, the image data is combined, overlayed, and/or integrated for analytical purposes.

In one embodiment, the artificial satellite includes a power system operable to produce enough power to support the plurality of sensors and/or analysis of image data captured by the plurality of sensors.

In order to provide sufficient power in order to support the multiple sensors onboard the satellite and the electric propulsion system of the satellite, in one embodiment, the satellite includes power systems providing approximately 1 kW of power. In one embodiment, the power is provided by one or more solar cells of the satellite, one or more batteries, and/or combinations thereof.

Referring now to the drawings in general, the illustrations are for the purpose of describing one or more preferred embodiments of the invention and are not intended to limit the invention thereto.

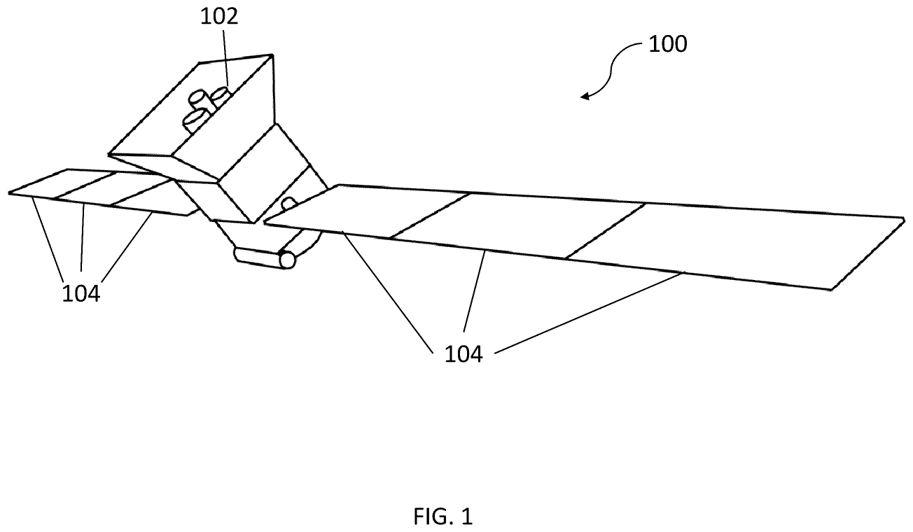

FIG. 1 illustrates a perspective view of an artificial satellite 100 with a plurality of sensors 102 according to one embodiment of the present invention. In one embodiment, the plurality of sensors 102 are mounted to a top center side of the artificial satellite 100. In one embodiment, the artificial satellite 100 includes a plurality of solar panels 104.

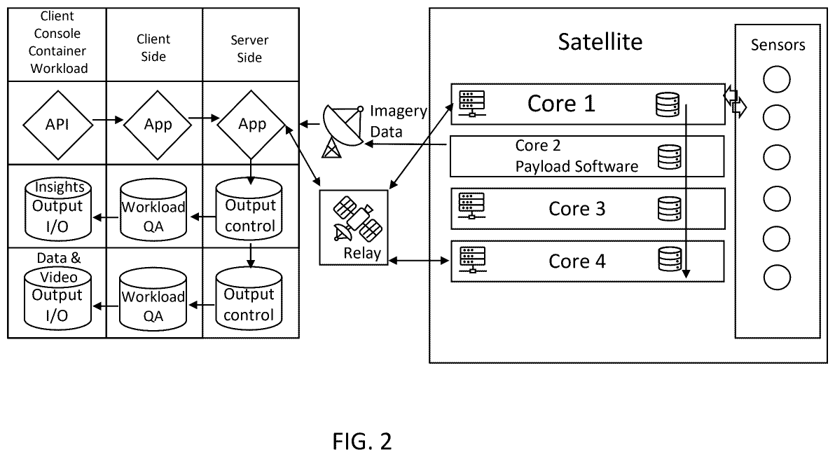

FIG. 2 illustrates a schematic diagram of data flow between a satellite having a plurality of sensors communicating with one or more ground stations. As shown in FIG. 2, a plurality of sensors onboard one or more satellites communicate sensor data with one or more core processors onboard the satellite. In one embodiment, the processors are split between those that receive signals from ground stations and/or relay satellites and those that process the sensor data, while, in another embodiment, the processors are capable of performing wide varieties of tasks.

The processors of the satellite are capable of receiving tasks, commands, and other messages from a server application in a ground station, optionally relayed through one or more intermediary satellite networks. The server application itself includes a client application programming interface (API) capable of receiving the commands of what server data to generate either directly from an operator or from automatic task generation (e.g., rules-based task generation, artificial intelligence task generation, etc.). A ground-based application is also capable of receiving imagery data processed by the satellite either at the same ground station or a different ground station from the one that originally transmitted the task. This imagery data is then able to be further processed for output control, stored in a ground or satellite-based database, and utilized to generate insights about a particular area or identified object, depending on the objectives of the task.

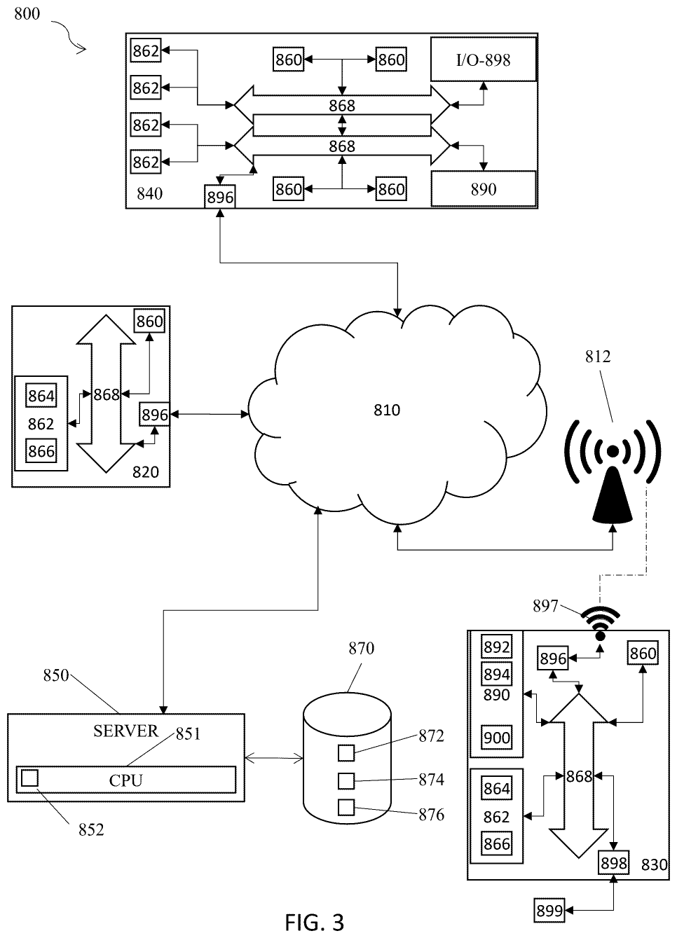

FIG. 3 is a schematic diagram of an embodiment of the invention illustrating a computer system, generally described as 800, having a network 810, a plurality of computing devices 820, 830, 840, a server 850, and a database 870.

The server 850 is constructed, configured, and coupled to enable communication over a network 810 with a plurality of computing devices 820, 830, 840. The server 850 includes a processing unit 851 with an operating system 852. The operating system 852 enables the server 850 to communicate through network 810 with the remote, distributed user devices. Database 870 is operable to house an operating system 872, memory 874, and programs 876.

In one embodiment of the invention, the system 800 includes a network 810 for distributed communication via a wireless communication antenna 812 and processing by at least one mobile communication computing device 830. Alternatively, wireless and wired communication and connectivity between devices and components described herein include wireless network communication such as WI-FI, WORLDWIDE INTEROPERABILITY FOR MICROWAVE ACCESS (WIMAX), Radio Frequency (RF) communication including RF identification (RFID), NEAR FIELD COMMUNICATION (NFC), BLUETOOTH including BLUETOOTH LOW ENERGY (BLE), ZIGBEE, Infrared (IR) communication, cellular communication, satellite communication, Universal Serial Bus (USB), Ethernet communications, communication via fiber-optic cables, coaxial cables, twisted pair cables, and/or any other type of wireless or wired communication. In another embodiment of the invention, the system 800 is a virtualized computing system capable of executing any or all aspects of software and/or application components presented herein on the computing devices 820, 830, 840. In certain aspects, the computer system 800 is operable to be implemented using hardware or a combination of software and hardware, either in a dedicated computing device, or integrated into another entity, or distributed across multiple entities or computing devices.

By way of example, and not limitation, the computing devices 820, 830, 840 are intended to represent various forms of electronic devices including at least a processor and a memory, such as a server, blade server, mainframe, mobile phone, personal digital assistant (PDA), smartphone, desktop computer, netbook computer, tablet computer, workstation, laptop, and other similar computing devices. The components shown here, their connections and relationships, and their functions, are meant to be exemplary only, and are not meant to limit implementations of the invention described and/or claimed in the present application.

In one embodiment, the computing device 820 includes components such as a processor 860, a system memory 862 having a random access memory (RAM) 864 and a read-only memory (ROM) 866, and a system bus 868 that couples the memory 862 to the processor 860. In another embodiment, the computing device 830 is operable to additionally include components such as a storage device 890 for storing the operating system 892 and one or more application programs 894, a network interface unit 896, and/or an input/output controller 898. Each of the components is operable to be coupled to each other through at least one bus 868. The input/output controller 898 is operable to receive and process input from, or provide output to, a number of other devices 899, including, but not limited to, alphanumeric input devices, mice, electronic styluses, display units, touch screens, gaming controllers, joy sticks, touch pads, signal generation devices (e.g., speakers), augmented reality/virtual reality (AR/VR) devices (e.g., AR/VR headsets), or printers.

By way of example, and not limitation, the processor 860 is operable to be a general-purpose microprocessor (e.g., a central processing unit (CPU)), a graphics processing unit (GPU), a microcontroller, a Digital Signal Processor (DSP), an Application Specific Integrated Circuit (ASIC), a Field Programmable Gate Array (FPGA), a Programmable Logic Device (PLD), a controller, a state machine, gated or transistor logic, discrete hardware components, or any other suitable entity or combinations thereof that can perform calculations, process instructions for execution, and/or other manipulations of information.

In another implementation, shown as 840 in FIG. 3, multiple processors 860 and/or multiple buses 868 are operable to be used, as appropriate, along with multiple memories 862 of multiple types (e.g., a combination of a DSP and a microprocessor, a plurality of microprocessors, one or more microprocessors in conjunction with a DSP core).

Also, multiple computing devices are operable to be connected, with each device providing portions of the necessary operations (e.g., a server bank, a group of blade servers, or a multi-processor system). Alternatively, some steps or methods are operable to be performed by circuitry that is specific to a given function.

According to various embodiments, the computer system 800 is operable to operate in a networked environment using logical connections to local and/or remote computing devices 820, 830, 840 through a network 810. A computing device 830 is operable to connect to a network 810 through a network interface unit 896 connected to a bus 868. Computing devices are operable to communicate communication media through wired networks, direct-wired connections or wirelessly, such as acoustic, RF, or infrared, through an antenna 897 in communication with the network antenna 812 and the network interface unit 896, which are operable to include digital signal processing circuitry when necessary. The network interface unit 896 is operable to provide for communications under various modes or protocols.

In one or more exemplary aspects, the instructions are operable to be implemented in hardware, software, firmware, or any combinations thereof. A computer readable medium is operable to provide volatile or non-volatile storage for one or more sets of instructions, such as operating systems, data structures, program modules, applications, or other data embodying any one or more of the methodologies or functions described herein. The computer readable medium is operable to include the memory 862, the processor 860, and/or the storage media 890 and is operable be a single medium or multiple media (e.g., a centralized or distributed computer system) that store the one or more sets of instructions 900. Non-transitory computer readable media includes all computer readable media, with the sole exception being a transitory, propagating signal per se. The instructions 900 are further operable to be transmitted or received over the network 810 via the network interface unit 896 as communication media, which is operable to include a modulated data signal such as a carrier wave or other transport mechanism and includes any delivery media. The term “modulated data signal” means a signal that has one or more of its characteristics changed or set in a manner as to encode information in the signal.

Storage devices 890 and memory 862 include, but are not limited to, volatile and non-volatile media such as cache, RAM, ROM, EPROM, EEPROM, FLASH memory, or other solid state memory technology; discs (e.g., digital versatile discs (DVD), HD-DVD, BLU-RAY, compact disc (CD), or CD-ROM) or other optical storage; magnetic cassettes, magnetic tape, magnetic disk storage, floppy disks, or other magnetic storage devices; or any other medium that can be used to store the computer readable instructions and which can be accessed by the computer system 800.

In one embodiment, the computer system 800 is within a cloud-based network. In one embodiment, the server 850 is a designated physical server for distributed computing devices 820, 830, and 840. In one embodiment, the server 850 is a cloud-based server platform. In one embodiment, the cloud-based server platform hosts serverless functions for distributed computing devices 820, 830, and 840.

It is also contemplated that the computer system 800 is operable to not include all of the components shown in FIG. 3, is operable to include other components that are not explicitly shown in FIG. 3, or is operable to utilize an architecture completely different than that shown in FIG. 3. The various illustrative logical blocks, modules, elements, circuits, and algorithms described in connection with the embodiments disclosed herein are operable to be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application (e.g., arranged in a different order or partitioned in a different way), but such implementation decisions should not be interpreted as causing a departure from the scope of the present invention.

Certain modifications and improvements will occur to those skilled in the art upon a reading of the foregoing description. The above-mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the present invention.

The invention claimed is:

1. An artificial satellite, comprising:
a plurality of computer processors each including a memory;
a plurality of sensors operable to capture image data; and
at least one transceiver;
wherein the plurality of computer processors includes at least one flight processor and at least one payload processor;
wherein the at least one payload processor is operable to automatically correct the image data via orthorectification, georectification, radiometric correction, and/or pan sharpening;
wherein the at least one payload processor includes an artificial intelligence engine operable to classify objects, identify objects, and/or tag objects within the image data; and
wherein the at least one payload processor is operable to fuse images having common object classifications, common object identifications, and/or common object tags.

2. The artificial satellite of claim 1, further comprising at least one solar cell operable to power the plurality of computer processors and the plurality of sensors.

3. The artificial satellite of claim 1, wherein each of the plurality of sensors are independently mounted on a separate gimbal.

4. The artificial satellite of claim 3, wherein each of the separate gimbals are operable to rotate about a plurality of axes.

5. The artificial satellite of claim 1, wherein the plurality of sensors include at least one Red, Green, Blue (RGB) video telescope, at least one hyperspectral sensor, at least one ultraviolet instrument, at least one infrared spectrometer, and/or at least one automatic identification system receiver.

6. The artificial satellite of claim 1, wherein the orthorectification includes generating a digital elevation model.

7. The artificial satellite of claim 6, wherein the digital elevation model uses a same sensor type oriented at a different angle or a different sensor type that includes the common object classifications, the common object identifications, and/or the common object tags.

8. The artificial satellite of claim 1, wherein correcting the image data does not require the image data to be transmitted to a ground station.

9. An artificial satellite, comprising:
a plurality of computer processors each including a memory;
a plurality of sensors operable to capture image data; and
at least one transceiver;
wherein the plurality of sensors are mounted to at least one gimbal;
wherein the plurality of computer processors includes at least one flight processor and at least one payload processor;
wherein the at least one payload processor is operable to automatically correct the image data via orthorectification, georectification, radiometric correction, and/or pan sharpening;
wherein the at least one payload processor includes an artificial intelligence engine operable to classify objects, identify objects, and/or tag objects within the image data; and
wherein the at least one payload processor is operable to fuse images having common object classifications, common object identifications, and/or common object tags.

10. The artificial satellite of claim 9, wherein correcting the image data does not require the image data to be transmitted to a ground station.

11. The artificial satellite of claim 9, wherein the at least one transceiver is operable to receive uplink messages from at least one ground station instructing the plurality of sensors to target a common destination.

12. The artificial satellite of claim 9, wherein the at least one flight processor is dedicated to processing tasks related to movement and navigation of the artificial satellite.

13. The artificial satellite of claim 9, further comprising at least one solar cell operable to power the plurality of sensors and the plurality of computer processors.

14. The artificial satellite of claim 9, wherein the plurality of sensors include at least one Red, Green, Blue (RGB) video telescope, at least one hyperspectral sensor, at least one ultraviolet instrument, at least one infrared spectrometer, and/or at least one automatic identification system receiver.

15. The artificial satellite of claim 9, wherein the at least one gimbal is operable to rotate about a plurality of axes.

16. The artificial satellite of claim 9, wherein the orthorectification includes generating at least one digital elevation model.

17. An artificial satellite, comprising:
a plurality of computer processors each including a memory;
a plurality of sensors operable to capture image data; and
at least one transceiver;
wherein the plurality of sensors are mounted to at least one gimbal;
wherein the at least one gimbal is operable to rotate about a plurality of axes;
wherein the at least one transceiver is operable to receive at least one uplink message from at least one ground station instructing the plurality of sensors to target a common destination;
wherein the plurality of computer processors includes at least one flight processor and at least one payload processor;
wherein the at least one payload processor is operable to automatically correct the image data via orthorectification, georectification, radiometric correction, and/or pan sharpening;
wherein the at least one payload processor includes an artificial intelligence engine operable to classify objects, identify objects, and/or tag objects within the image data; and
wherein the at least one payload processor is operable to fuse images having common object classifications, common object identifications, and/or common object tags.

18. The artificial satellite of claim 17, wherein correcting the image data does not require the image data to be transmitted to a ground station.

19. The artificial satellite of claim 17, wherein the orthorectification includes generating a digital elevation model.

20. The artificial satellite of claim 19, wherein the digital elevation model uses a same sensor type oriented at a different angle or a different sensor type that includes the common object classifications, the common object identifications, and/or the common object tags.
